(19) United States
(12) Patent Application Publication
(10) Pub. No.: US 2003/0046792 A1
(43) Pub. Date: Mar. 13, 2003

(54) Hinge with integral damping

(75) Inventors: Richard P. Thorn, Erie, PA (US); Peter A. Masterson, Erie, PA (US); Neil J. Donovan, Erie, PA (US)

Correspondence Address: Michael M. Gnibus, Lord Corporation, Legal & Patent Services, Post Office Box 8012, Cary, NC, 27512-8012, US

(73) Assignee: Lord Corporation

(21) Appl. No.: 09/949,455

(22) Filed: Sep. 7, 2001

(51) Int. Cl. E05D 11/08

(52) U.S. Cl. 16/342

(57) ABSTRACT

A hinge comprising a first hinge attachment member; a second hinge attachment member, the first and second hinge attachment members being movable relative to each other; and a coupling member for coupling the first and second hinge attachment members and for supplying damping when the first and second attachment members are displaced relative to each other. The damping is comprised of surface effect damping and such damping may be direction dependent or dependent on the rate of displacement or acceleration of one of the members. The hinge includes means for adjusting the magnitude of the damping supplied.

### FIELD OF THE INVENTION

The invention relates to a hinge and more specifically the invention relates to a hinge having a first attachment member and a second attachment member where the attachment members are relatively movable about an axis, and a coupling member that couples the first and second attachment members and provides integral damping to control the relative displacement between the first attachment member and the second attachment member.

### BACKGROUND OF THE INVENTION

Hinges generally join first and second members to produce the desired relative member displacement and such relative displacement may be comprised of either displacement of both the first and second members or of displacement of one of the members while the other member remains in a fixed position. Frequently hinges are used to join a doorjamb or frame 14 and a door 18 as shown in FIG. 1. In the conventional hinge 10 of FIG. 1, a first attachment member 12 is fixed to the stationary door frame 14 and second attachment member 16 is fixed to the door 18 to be movable with the door. The first and second attachment members are fixed to the frame and door in a conventional manner such as by suitable screws for example. The unitary first and second attachment members 12 and 16 include at least one outwardly directed collar identified as 20 and 21 respectively in FIG. 1. The collars are located along a free plate edge so that when it is necessary to hang the door in the frame the first and second plates are mated, and when mated the collars 20 and 21 define an axially extending channel 22 that receives a pin 24 which prevents the plates from separating after the door is hung. The pin is a rigid metal member and the pin defines an axis 26 about which the door is moved between open and closed positions.

Prior art hinges provide a spring or energy storage means for producing relative displacement between first and second members but do not control the relative displacement of the members. As a result, typical hinge technology does not include means for limiting or controlling the rate at which the first and second members are moved toward and away from each other. Referring to the hinge of FIG. 1 to demonstrate this shortcoming, because the conventional hinge 10 does not include integral means for controlling the rate at which door 18 is moved toward and away from frame 14. The conventional hinge 10 can not prevent the door from slamming against the jamb or from opening uncontrollably.

In order to overcome this shortcoming in conventional hinges, if a door is susceptible to slamming or uncontrolled opening, the door is frequently fitted with a discrete device such as a damper that produces the desired controlled relative motion between the door and frame. Such devices are mounted between the top of the door and the door frame. And are typically actuated pneumatically or hydraulically. Such devices are quite expensive and as a result, it is not possible to install such devices in every application. Additionally, where installed, such devices leak and require regular maintenance.

The foregoing illustrates limitations known to exist in present hinges. Thus, it is apparent that it would be advantageous to provide an alternative hinge directed to overcoming the limitations set forth above. Accordingly, a suitable alternative hinge is provided including features more fully disclosed hereinafter.

### SUMMARY OF THE INVENTION

In one aspect of the present invention this is accomplished by providing a hinge that provides integral hinge damping for controlling the relative motion between about an axis between first and second attachment members. By way of example, but not intended to be limiting, the hinge of the present invention may be used to control relative motion between a vehicle door and vehicle frame, a door in a residence or business and its associated frame, or between an appliance door such as a refrigerator or freezer door and the refrigeration or freezer storage compartment. In summary, it is anticipated that the hinge of the present invention may be included between any relatively movable components where it is desirable to control the relative motion therebetween.

The hinge of the present invention comprises a first attachment member; a second attachment member, the first and second attachment members being movable relative to each other; and a coupling member for coupling the first and second attachment members and for supplying damping when the first and second members are displaced relative to each other. The integral hinge damping is comprised of surface effect damping and the damping supplied by the coupling member may be dependent on the direction, velocity or magnitude of displacement of one or both of the members. The supplied rate of damping may also be adjusted at the hinge.

The hinge of the present invention may include damping layers or elements that are offset by an angle to produce damping that is dependent on the relative displacement of the shaft of the hinge coupling member. By offsetting the damping layers the hinge may comprise damping zones where the damping is increased during specific shaft displacement and is decreased during other specific shaft displacement. Additionally, the hinge may include resilient members that provide surface effect damping as the coupling member shaft is moved past the members and such hold open members also include retention shoulders so that as the shaft is displaced past the shoulders counterrotation of the shaft is prevented unless a force of sufficient magnitude the shaft shoulder engagement is supplied to the door, lid etc. The members may also be oriented to limit inadvertent opening of the door.

The coupling member may also include a damping release that is actuated as the attachment members are proximate each other. Once the damping release is engaged the diameter of a C-clamp is increased thereby limiting the surface effect damping forces. The coupling member shaft may include a relief so that a portion of the shaft has a minimum diameter and a portion of the shaft has a maximum diameter. When a resilient element is located between the minimum diameter of the shaft and a passageway wall a minimum damping force is supplied and when the resilient layer is located between the wall and the maximum diameter pin portion a maximum damping force is supplied. The hinge coupling member may include damping elements that are movable through engagement with the rotating coupling shaft. Accelerated shaft rotation moves the shaft into further engagement with the damping element shoes and thereby increase the contact forces between the damping element resilient layer and the passageway wall to increase the surface effect damping.

The foregoing and other aspects will become apparent from the following detailed description of the invention when considered in conjunction with the accompanying drawing figures.

### BRIEF DESCRIPTION OF THE DRAWINGS

FIG. 1 is schematic representation of a prior art hinge joining a door to a frame.

FIG. 2A is an exploded view of a first embodiment hinge member of the present invention.

FIG. 2B is a partial view of the first embodiment hinge of FIG. 2A showing the first embodiment hinge assembled.

FIG. 3 is a partial view of an assembled second embodiment hinge of the present invention.

FIG. 4 is a longitudinal sectional view of an assembled third embodiment hinge member of the present invention.

FIG. 5 is an isometric view of the clamp member of the coupling of the third embodiment hinge.

FIG. 6 is a lateral sectional view taken along line 6-6 of FIG. 4.

FIG. 7 is a longitudinal sectional view of a fourth embodiment hinge of the present invention.

FIG. 8A is a sectional view taken along line 8A-8A of FIG. 7.

FIG. 8B is a lateral section view like FIG. 8A showing an alternate configuration of the damping layers of the fourth embodiment hinge.

FIG. 9A is the sectional view of FIG. 8A with the coupling member shaft rotated into friction engagement with the damping layers.

FIG. 9B is the sectional view of FIG. 8B with the coupling member shaft rotated into friction engagement with the alternate configuration damping layers.

FIG. 10 is a longitudinal sectional view of a fifth embodiment hinge of the present invention.

FIG. 11A is the sectional view taken along line 11A-11A of FIG. 10.

FIG. 11B is a lateral section like FIG. 11A showing an alternate configuration for the damping layers.

FIG. 12 is a longitudinal sectional view of a sixth embodiment hinge of the present invention.

FIG. 13 is a longitudinal sectional view of the coupling shaft of the sixth embodiment hinge taken along line 13-13 of FIG. 12.

FIG. 14 is a side view of a single damping shoe of the sixth embodiment hinge.

FIG. 15A is a lateral sectional view of an alternate embodiment hinge coupling member that includes velocity dependent damping elements.

FIG. 15B is the lateral sectional view of FIG. 15A with the shaft rotated into engagement with the damping elements.

FIG. 16A is a lateral sectional view of an alternate embodiment hinge coupling member that provides integral damping and position checking.

FIG. 16B is the sectional view of FIG. 16A with the shaft rotated clockwise past the position checking shoulders.

FIG. 16C is a lateral sectional view of an alternate embodiment hinge coupling member that provides integral damping and position checking.

FIG. 17 is an alternate embodiment coupling member.

FIG. 18 is a lateral sectional view taken along line 18-18 of FIG. 17.

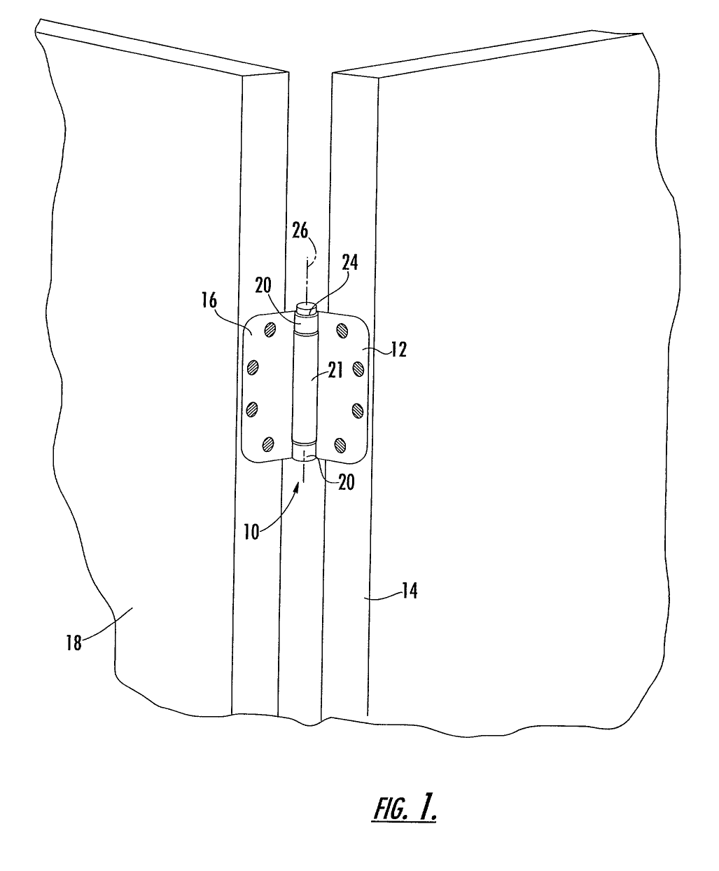

### DETAILED DESCRIPTION OF THE PREFERRED EMBODIMENTS

Now turning to the drawing Figures wherein like members are referred to by the same numbers in all the views, generally, the hinge of the present invention provides integral damping as the first and second attachment members are displaced relative to each other. As will be described further as the description of the preferred embodiments of the invention proceeds, the damping supplied by the hinge may be dependent on the direction of hinge member displacement and may only be supplied when the first and second members are moved in a specific manner; the magnitude of the supplied damping may be dependent on the magnitude of member displacement; the magnitude of the supplied damping may be dependent on the magnitude of the velocity of one or both of the attachment members; and the magnitude of the supplied damping may adjusted in a variety of ways as will be described hereinafter.

As the description proceeds, the supplied integral damping may be referred to by any or all of the terms “surface effect”, “surface effect damping” and “surface effect damper”. As used in this application these terms shall mean damping that comprises a combination of friction, viscous and hysteretic damping resulting from relative motion of two surfaces. The surface effect damping may also comprise viscoelastic damping when a lubricant is applied to the damping members. The relative motion can be sliding motion, or rolling motion for example. One of the surfaces that contributes to the surface effect damping is typically a resilient material and such surface may be impregnated with a lubricant. Alternatively, a thin layer of lubricant may be applied between the surfaces.

Unless otherwise indicated specifically hereinbelow, as the description proceeds the hinge disclosed in each of the preferred embodiments of the hinge will include a first attachment member 41 fixed to a stationary frame and a second attachment member 43 fixed to a movable member such as a door to be movable therewith. It should be understood that the inventors do not wish or intend to limit the application of the hinge with integral damping of the present invention to applications where one attachment member is fixed and is not free to move and the other attachment member is free to move. The hinge of the present invention is suitable for use where both attachment members are movable or for use where multiple pivot axes are linked together such as in multi-bar linkages.

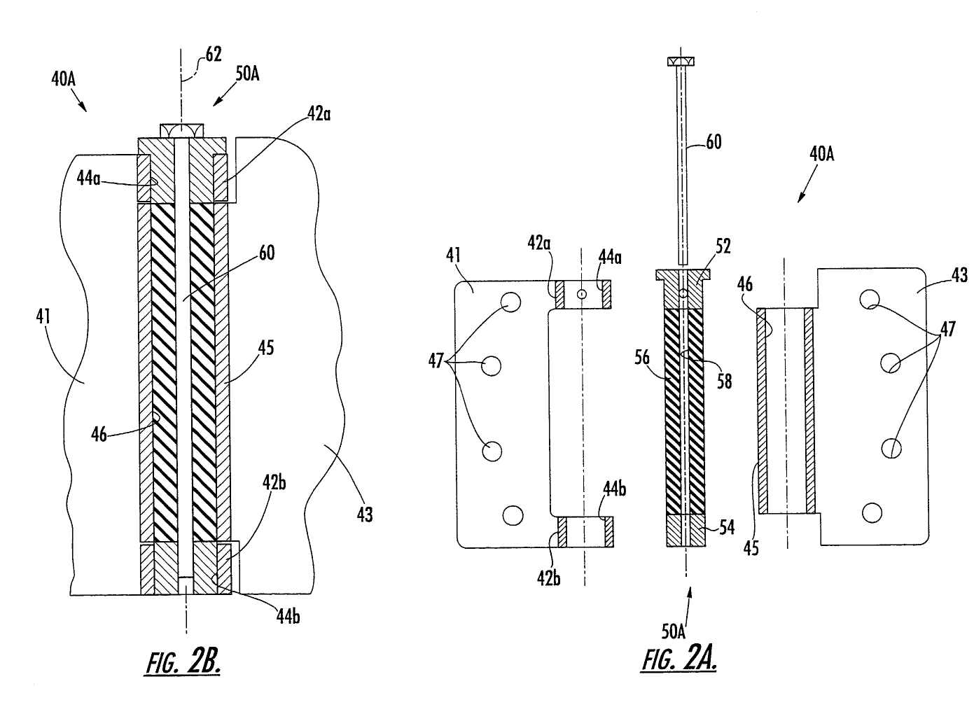

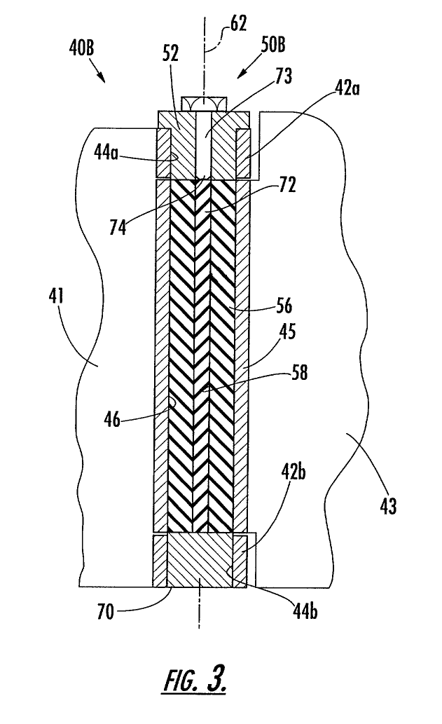

The first embodiment of the present invention hinge is illustrated in FIGS. 2A and 2B and is referred to at 40A. Hinge 40A comprises unitary first attachment member 41 that has upper and lower hollow cylindrical collars 42a and 42b that define respective openings 44a and 44b that extend through the collars. As shown in FIG. 2A, the first attachment member 41 has a C-shaped configuration with the collars 42a and 42b separated by a distance. Hinge 40A also comprises unitary second attachment member 43 having a tubular collar 45 that defines passageway 46. As shown in FIG. 2B, when the first and second members are mated, tubular collar 45 is located between discrete collars 42a and 42b and the passageways 44a, 44b and 46 are aligned along axis 62 to define a channel or passageway adapted to receive a coupling member, identified in FIGS. 2A and 2B as 50A.

For purposes of describing the preferred embodiments of the present invention both the first and second attachment members 41 and 43 are planar and the members 41 and 43 are attached to their respective members by conventional attachment means such as bolts, screws or the like (not shown) that are passed through openings 47 provided in members 41 and 43. However alternatively the members 41 and 43 may comprise any suitable configuration and may be attached to a respective movable member or frame by a weld connection or other suitable means.

As indicated above, coupling member 50A is located in the passageway defined by collars 42a, 42b and 45. The coupling member 50A serves to couple the first and second members 41 and 43, to define axis 62 about which attachment member 43 is movable toward and away from attachment member 41 and to provide integral damping during relative displacement of the members 41 and 43. The damping is comprised of surface effect damping and the damping is supplied as at least one of the members 41 and 43 is displaced relative to the other member.

The coupling member 50A includes outer rigid bearing members 52 and 54 that are made integral with resilient member 56 at the resilient member ends by a suitable adhesive such as Chemlok adhesive supplied by Lord Corporation of Erie, Pennsylvania. As shown in FIG. 2A, channel 58 extends axially through the bearings 52, 54 and the resilient member 56. Elongate adjustment member 60, such as a threaded bolt, is adapted to be inserted in the adjustment channel. The portions of channel 58 defined by rigid bearing members 52 and 54 are threaded so that as the threaded adjustment member is inserted in passageway 58, it may be threadably connected to bearing members 52 and 54. Typically both bearings 52 and 54 are rotationally fixed to respective collar members 44a and 44b by a laterally extending conventional pin connection. The pin is inserted in openings provided in the collar and bearings. However, alternatively only one bearing 52 or 54 may be rotationally fixed to its respective collar.

Turning now to FIG. 2B, as seated in the assembled passageway, the resilient member 56 is located in passageway 46 and the bearings 52 and 54 are located in passageways 44a and 44b respectively with the flange of bearing 52 seated on collar 42a. The resilient member 56 has substantially the same length as the collar 45. As located in passageway 46, and before adjustment member 60 is inserted in channel 58 the outer surface of the resilient member 56 is in light contact with inner wall of the collar 45. As the adjustment means is inserted through the channel 58 into threadable engagement with bearings 52 and 54 and tightened along axis 62, the bearing members 52 and 54 are drawn together and axially compress the resilient member 56 causing the resilient element 56 to bulge radially outwardly along its length. The outward bulge increases the contact force produced between the resilient element 56 and collar 45. Increasing the outward bulge increases the frictional component of the surface effect damping supplied by the hinge.

In summary, the first embodiment hinge 40A provides damping as the attachment plate 43 is moved away from and toward the fixed plate 41 as a door or other movable member is opened and closed. The damping is not direction dependent and damping is supplied through the full range of member 43 displacement. Friction contact between the resilient element 56 and collar 46 as the collar is moved past the resilient element produces dynamic surface effect damping. The magnitude of the supplied damping may be adjusted by tightening or loosening the adjustment member 60 thereby increasing or decreasing the outward bulge of the resilient member 56.

A second embodiment hinge 40B is illustrated in FIG. 3. The second embodiment hinge comprises first and second attachment members 41 and 43 as previously described and coupling member 50B substantially as described in conjunction with the first embodiment hinge 40A. Unlike channel 58 of coupling member 50A that extends axially through the coupling member, channel 58 of the second embodiment coupling member SOB terminates at closed bearing 70 seated in passageway 44b and fixed to one end of resilient member 56. The bearing member 52 previously described is fixed to the opposite resilient member end.

A resilient pin 72 is inserted in channel 58 and the preferred pin is a slender cylindrical rod that is most preferably comprised of a soft rubber. The inserted pin substantially fills the channel 58 and is in light contact with the channel wall with one pin end located against or proximate closed bearing 70 and the opposite pin end adjacent bearing member 52. It should be understood that the pin may comprise any suitable configuration that produces the desired bulge and contact forces with resilient member 56. For example, in addition to the slender cylindrical shape illustrated in FIG. 3, the pin 72 may include a tapered body.

Damping adjustment member 73 is inserted in bearing 52. The adjustment member may be a threaded bolt for example. Turning to FIG. 3, as the end 74 of the member 73 passes through the bearing 52, the end contacts the end of pin 72 adjacent bearing 52. The pin is compressed between member 70 and adjustment member 73, and such compression causes the pin 72 to expand or bulge radially outwardly along the axial pin length to thereby increase the contact force between pin 72 and resilient element 56. The increased contact force between the pin and resilient member 56 in turn causes the resilient member 56 to expand or bulge radially outwardly along axis 62 to increase the contact force between the resilient element 56 and collar 45. In this way the magnitude of the supplied damping is increased. By loosening the member 73, the bulge in pin 72 is decreased and with it the damping force. As plate 43 is displaced about axis 62, the second embodiment hinge 40B provides dynamic integral surface effect damping by the frictional engagement between the collar 46 and the resilient member 56.

In summary, the like the first embodiment hinge, the second embodiment hinge 40B provides damping as the attachment plate 43 is moved away from and toward the fixed plate 41 as a door or other movable member is opened and closed. The damping is not direction dependent and damping is supplied through the full range of member 43 displacement. Friction contact between the resilient element 56 and collar 46 as the collar is moved past the resilient element produces dynamic surface effect damping. The magnitude of the supplied damping may be adjusted by tightening or loosening the adjustment member 73 thereby increasing or decreasing the outward bulge of the resilient member 56.

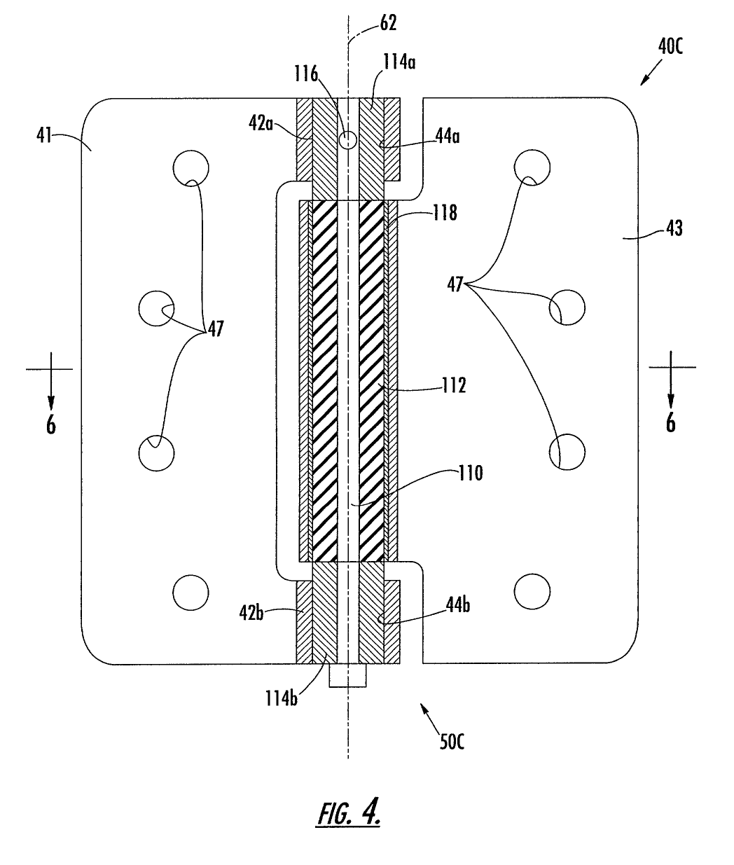

A third embodiment hinge of the present invention 40C is illustrated in FIGS. 4-6. The third embodiment hinge comprises first and second attachment members 41 and 43 as previously described. In the third embodiment hinge, attachment member 43 is fixed to a frame and attachment member 41 is movable relative to member The third embodiment hinge also comprises coupling member 50C that provides integral surface effect damping as attachment member 43 is displaced about axis 62. The damping element 50C is comprised of an elongate shaft 110 with a portion of the shaft length covered by a layer of resilient material 112 such as rubber. Bearing members 114a and 114b are fixed to the ends of the shaft and in abutment with member 112 and the bearings are in turn seated in respective collars 42a and 42b. The bearing 114a may be connected to the collar 42a by a conventional radially extending pin connection 116 that extends laterally through the collar 42a, shaft 110 and bearing 114a. In this way, the coupling member is movable with the attachment member 41 during displacement of attachment member 41. The resilient material 112 is bonded to the shaft 110 using a conventional adhesive as described hereinabove.

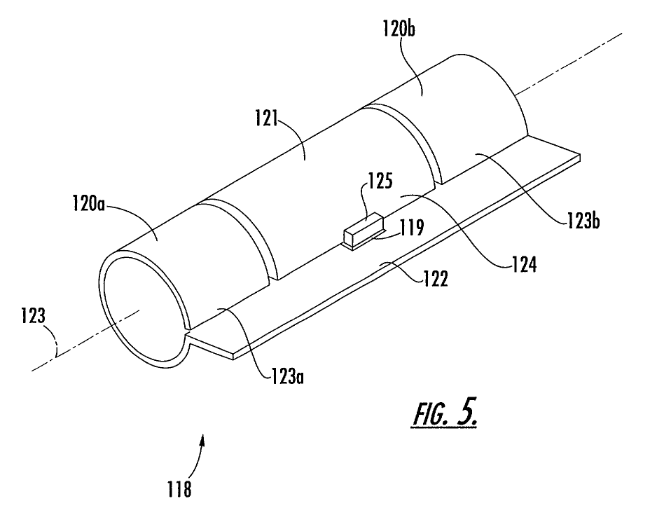

The desired surface effect damping is produced as a result of friction engagement between the resilient layer 112 and flexible C-shaped clamp 118 that surrounds the resilient element 112. See FIGS. 5 and 6. Like the hinges 40A and 40B, hinge 40C provides bi-directional damping. During door opening, as the attachment member 41 is moved away from attachment member 43 that is fixed to the frame for example. As the member 41 is rotated about axis 62 clockwise, the diameter of the C-shaped member increases decreasing the frictional contact forces between the resilient element 112 and clamp 118 and ultimately decreasing the magnitude of the supplied surface effect damping. When the door is closed and the attachment member 41 is moved toward member 43, the diameter of the C-shaped clamp decreases thereby increasing the contact forces between the clamp 118 and the resilient element 112 and ultimately increasing the supplied surface effect damping forces.

The unitary tubular C-clamp 118 is shown in FIG. 5 and generally includes clamp end sections 120a and 120b and middle section 121 with each section separated from the adjacent section by a gap. The unitary clamp 120 includes a radially outwardly directed flange member 122 that joins the three sections. As shown in FIG. 6 the flange member is seated against a free end of collar 45 and by this contact the clamp is moved with the attachment member 41. Each section 120a, 120b and 121 extends around axis 123 with a substantially constant radius and each section terminates at a respective free end 123a, 123b and 124 proximate flange 122. Referring to FIGS. 5 and 6, damping relief tab 125 extends through flange 122 and the tab is comprised of a portion of the section 121. As shown in FIG. 6, the damping relief tab is comprised of a portion of the middle section 121 cut away from the remainder of the section with one end of the tab connected to the section 121 and the free end extending through a slot 119 provided along the length of flange 122. When the attachment member 41 is moved toward fixed member 43 relief tab 125 contacts member 43 and as a result, the relief tab is directed inwardly causing the radius of the middle section 121 to increase thereby decreasing the friction contact forces as the section 121 is urged away from the resilient member 112 and thereby effectively decreasing the supplied surface effect damping. In order to facilitate the displacement of tab 125, a recess or relief 127 is provided in collar 45. The recess may extend partially or completely around the collar. As shown in FIG. 6, the recess extends partially around collar 45.

In summary, third embodiment hinge member 40C provides damping in clockwise and counterclockwise directions of displacement of member 41 about axis 62 by friction contact between resilient element 112 and clamp member 118. The clamp member includes a damping relief tab that is contacted by member 43 when the movable attachment member 41 is proximate member 43 causing the circumference of the clamp to increase thereby decreasing the contact forces between the resilient element and the clamp. The damping is direction dependent and drops off a controlled amount as the tab is displaced as members 41 and 43 come together.

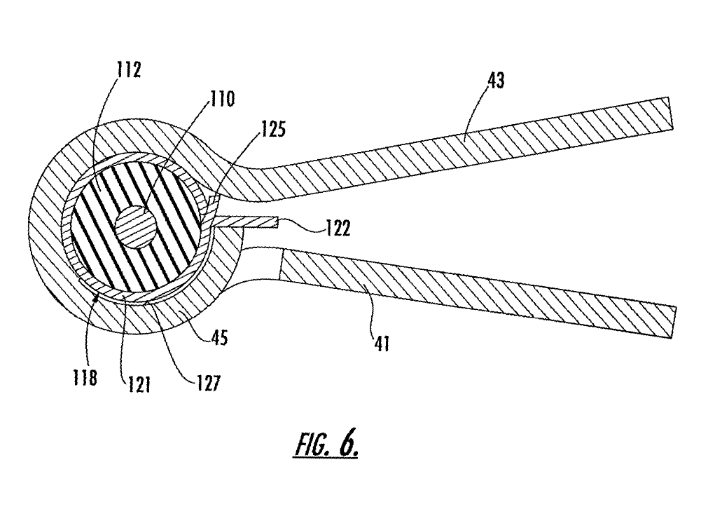

Fourth embodiment hinge 40D is illustrated in FIGS. 7, 8A, 8B, 9A and 9B. As will be described hereinbelow, the fourth embodiment hinge 40D provides damping when the attachment member 41 is moved toward and away from fixed attachment member 43. Unlike the hinge 40A, in hinge 40D attachment member 43 is fixed and member 41 is free to rotate about axis 62 toward and away from the fixed member 43.

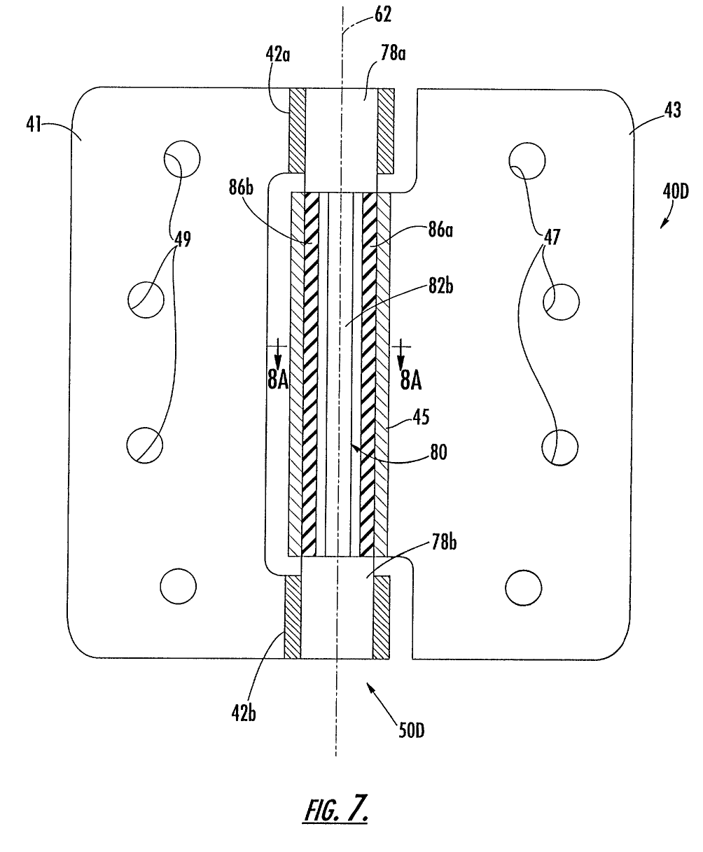

The fourth embodiment hinge 40D comprises first attachment member 41, second attachment member 43 previously described and coupling member 50D. The coupling member includes cylindrical bearings 78a and 78b that are joined by rigid shaft 80. The bearings are respectively supported by previously described collars 42a and 42b. Bearing 78a is maintained in collar 42a by a conventional radially extending pin connection (not shown) and by such connection the shaft 80 is made to move with the attachment member 41. As shown in FIG. 8A, the shaft has a rectangular cross section defined by pairs of opposed faces identified as 84a, 84b and 82a, 82b in FIG. 8A.

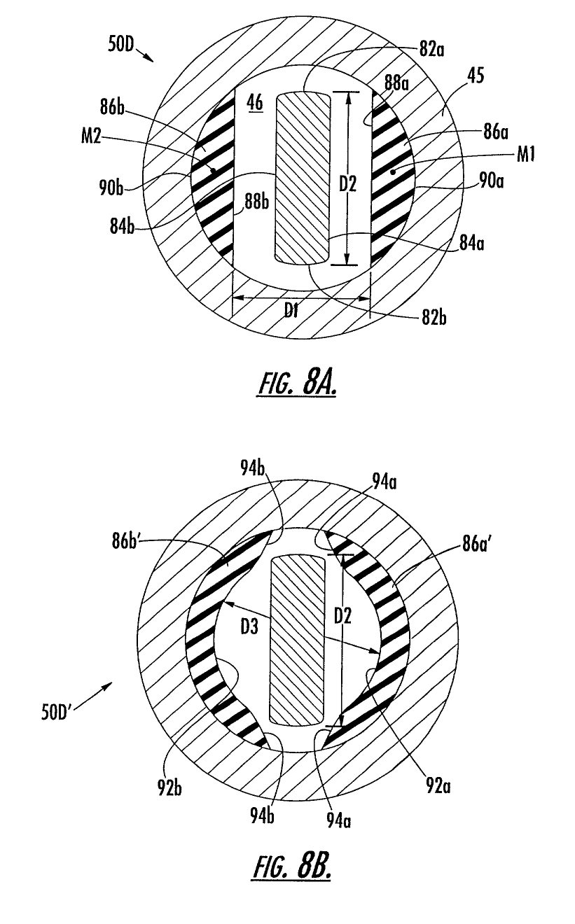

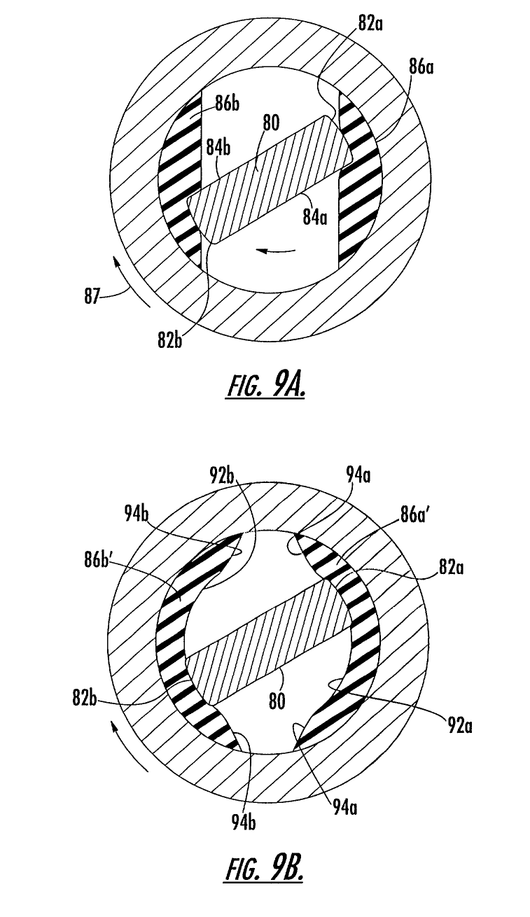

Diametrically opposed semi-cylindrical resilient layers 86a and 86b are made integral with the wall that defines passageway 46 of collar 45 using a suitable conventional adhesive as previously described. As shown in FIG. 7, the resilient layers extend axially along the entire length of the passageway. However it should be understood that the layers may comprise any suitable axial dimension. Additionally, although the layers are shown as being separated by 180° any suitable angle may separate the resilient layers. The solid layers 86a and 86b are bound by respective, substantially planar and inwardly directed surfaces 88a and 88b and convex outwardly directed surfaces 90a and 90b that are made integral with the surface that defines collar passageway 46. Turning to FIGS. 8A and 9A, the dimension D2 of faces 84a and 84b is greater than the dimension D1 separating surfaces 88a and 88b and as a result, when the coupling member is rotated about axis 62, at an angle of about 45° from the position of FIG. 8A, the ends 82a and 82b of the shaft 80 contact the layers to supply damping to the shaft 80 and ultimately to the hinge 40D. In FIG. 9A, the shaft 80 is rotated clockwise as indicated by arrow 87.

Turning now to FIG. 8A, as the door is closed and the attachment member is moved toward member 43, the shaft is rotated counterclockwise about axis 62. Initially, the ends 82a and 82b are not in contact with layers 86b and 86a. Continued rotation of shaft counterclockwise moves ends 82a and 82b into engagement with the respective surfaces 88b and 88a. As the shaft is rotated and the ends continue to frictionally contact the layers the contact forces and ultimately the damping forces increase as the force of layer compression increases due the increased layer thickness. The surface effect damping increases until the ends pass the center of the layers identified as M1 and M2 and then decrease until the shaft ends are moved out of engagement with the layers. Thus the coupling member 50D provides damping that has a magnitude that is dependent on the magnitude of the shaft displacement. Using FIG. 8A as a reference, 45° of shaft rotation relative to the position of FIG. 8A produces damping forces to the hinge, 90° of shaft rotation relative to the position of FIG. 8A provides increased damping forces to the hinge and 135° of shaft rotation relative to the position of FIG. 8A provides damping that is less than the damping at 90° of shaft rotation. Once the shaft has been rotated 180° no damping is supplied to the hinge. The reverse of this cycle is obtained when the hinge is rotated back to its original position. The damping is provided during movement of the attachment member toward and away from the fixed member 43. Thus the damping in hinge 40D with layers 86a and 86b is variable.

The resilient layers made integral with passageway 46 may assume any suitable configuration. A suitable alternate resilient layer configuration is illustrated in FIGS. 8B and 9B and the layers are identified as 86a′ and 86b′ in the Figures. The alternate embodiment layers are separated diametrically and as shown in FIGS. 8B and 9B, the substantially planar surface 88a and 88b is replaced by substantially concave surface 92a and 92b. The peripheral portions of the concave surfaces terminate at substantially planar surfaces 94a and 94b. In this way, the shaft 80 gradually engages the surfaces 92a and 92b as shown in FIG. 9B and then once in engagement with the surfaces provides substantially constant damping forces.

Turning to FIG. 8B, the width dimension D2 of surfaces 84a and 84b is substantially the same as the diametrically extending distance D3 between the convex portions 92a and 92b of layers 86a′ and 86b′. As a result, surfaces 82a and 82b contact layers 86a′ and 86b′ substantially tangentially and the thickness of the layers are substantially constant resulting in substantially constant forces of compression. Now turning to FIG. 9B, as a result, the surfaces 82a and 82b substantially tangentially contact the concave surfaces 92a and 92b as the first and second attachment members are displaced relative to each other. The transition surfaces 94a and 94b are directed outwardly and as a result, the shaft 80 does not move into contact with the layers as the shaft is displaced past the transition surfaces until the shaft is moved past the concave portion of the layers 86a′ and 86b′. With the exception of the variability of the damping forces as a function of angular displacement, alternate embodiment coupling 50D′ functions as previously described for coupling 50D.

In summary, hinge 40D provides damping in both directions of rotation of attachment member 41. The damping may be dependent on the magnitude of the displacement of the attachment member or may be independent of displacement of the member 41. The damping layers may have a constant thickness cross section or a variable thickness cross section.

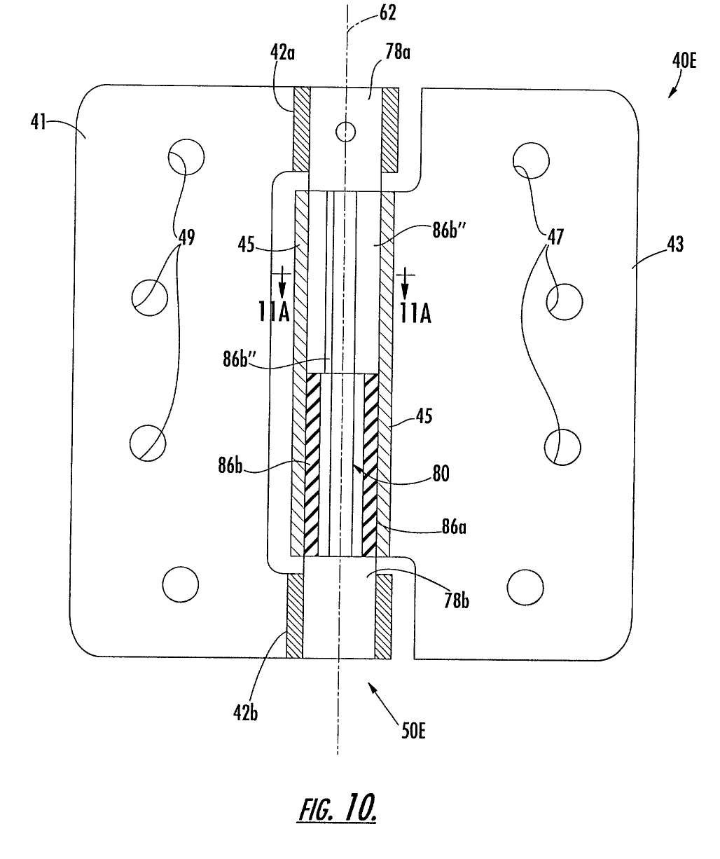

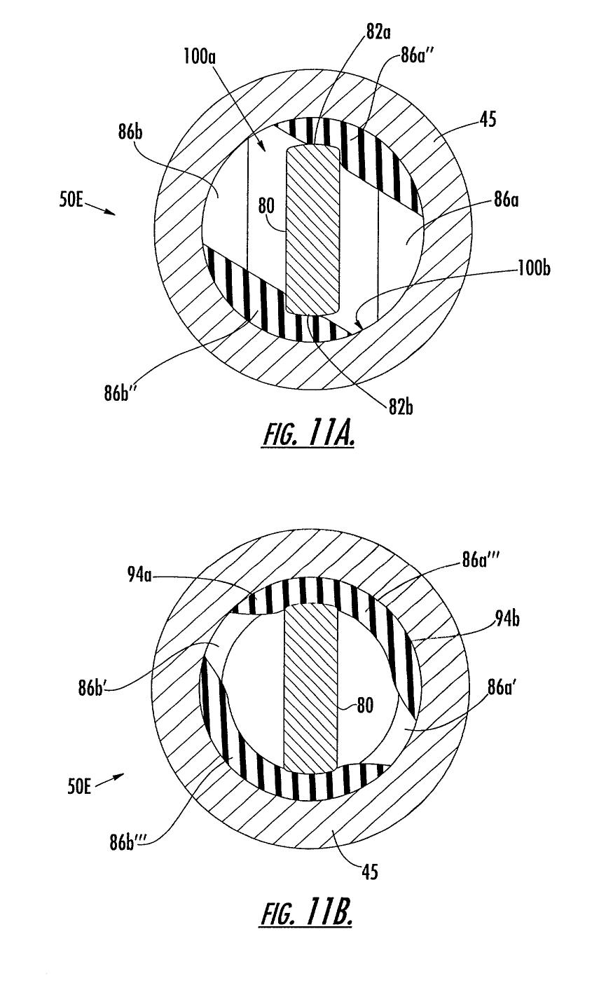

A fifth embodiment hinge member 40E is disclosed in FIGS. 10, 11A and 11B. The fifth embodiment hinge is substantially the same as fourth embodiment hinge 40D previously described however coupling member 50E has been modified from embodiment hinge 40D. The previously described longitudinally extending hinge damping layers 86a and 86b are replaced with layers 86a and 86b that extend from one end of passage way 46 to the center of the collar 45 and layers 86a″ and 86b″ that extend from the termination of layers 86a and 86b to the opposite end of passageway 46. As shown in FIG. 11A, the layers 86a, 86a″ and 86b, 86b″ are offset about axis 62 by an angle of counterclockwise rotation of about sixty degrees (60°) however it should be understood that the layers may be offset from each other by any suitable angle.

The fifth embodiment hinge 40E also includes layers 86a′″ and 86b′″ previously described in conjunction with fourth embodiment hinge 40D as layers 86a′ and 86b′. The layers 86a′″ and 86b′″ are offset from respective layers 86a′ and 86b′ by an angle of counterclockwise rotation of about sixty degrees. Layer 86b′ and 86a′ extend from one end of collar 45 to substantially the center of the collar passageway 46 and the layers 86a′″ and 86b′″ extend from the termination of layers 86a′ and 86b′ to the opposite end of the collar passageway.

Thus as the shaft 80 is rotated as the first attachment member 41 and second attachment member 43 are moved relative to each other, the shaft 80 frictionally engages the damping layers during shaft displacement through defined angles of rotation. The thickness of the rubber layer increases to a maximum thickness at the physical center of the layers. As a result, the maximum compressive forces acting on layers 86a, 86a″, 86b and 86b″ occur at the center of the layers and the minimum compressive forces are produced at the leading and trailing layer ends. Thus the friction damping increases as the shaft rotates through the center of the layer and then decreases as the shaft 80 approaches the leading and trailing layer ends

The fifth embodiment hinge supplies damping in both directions of rotation about axis 62. In the embodiment of FIG. 11A, as the shaft surfaces 82a and 82b travel through zones 100a and 100b separating layers 86a, 86a′″ and 86b, 86b′″, the surfaces are not in substantial frictional engagement with any of the damping layers and minimal damping is supplied. Immediately after being rotated through zones 100a and 100b, the surfaces engage the next adjacent layer in the direction of rotation. After engaging the layer, the surface effect damping increases until the shaft passes the center of the layer and then decreases as the shaft approaches the layer end. When the shaft reaches the transition from layer 86a″ to layer 86a and from layer 86b″ to layer 86 the surface effect damping magnitude is again increased. The surface effect damping magnitude increases and decreases over the full shaft rotation.

The alternate embodiment hinge 40E provides continuous damping as the shaft is rotated and the damping is increased as the shaft is swept through transition surfaces 94a and 94b of layers 86′, 86b′″ and 86a′, 86a′″. The alternate embodiment layers provide a contact surface that is substantially defined by a constant radius from the center of the passageway 46. In this way, the compressive forces between the shaft surfaces 82a and 82b remain constant through the full rotation of the shaft. The surface effect damping is varied by varying the surface area of contact between the shaft surfaces and layers 86a′. 86a′″, 86b′ and 86b′″. When the shaft is in contact with layers 86a′. 86a′″, 86b′ and 86b′″ the surface effect damping is at a maximum. The surface area and ultimately the frictional damping are reduced as the shaft surfaces 82a and 82b travel to the end of the transition surfaces 94a and 94b as the shaft surface are in engagement with only one layer. The single layer and double layer contact alternate approximately every forty-five degrees of shaft rotation. In the embodiment of FIG. 11B damping is doubled and halved as the member rotates about axis 62 into contact with both damping layers and one damping layer.

In summary, the fifth embodiment hinge provides variable damping as the shaft is angularly displaced in the passageway about axis 62. Damping is supplied in both clockwise and counterclockwise directions of rotation of the shaft. It should be understood that the damping layers may comprise any suitable configuration. The layers do not have to have the same cross section and the layers may be separated by any suitable angle to produce the desired damping affect. By varying the profiles and damping timing, the impingement or engagement between the damping layer and shaft and the frequency of the onset of damping can be modified as required. Additionally, although shaft 80 is disclosed as having a substantially constant cross section, the shaft cross section may be modified to provide variable surfaces contact.

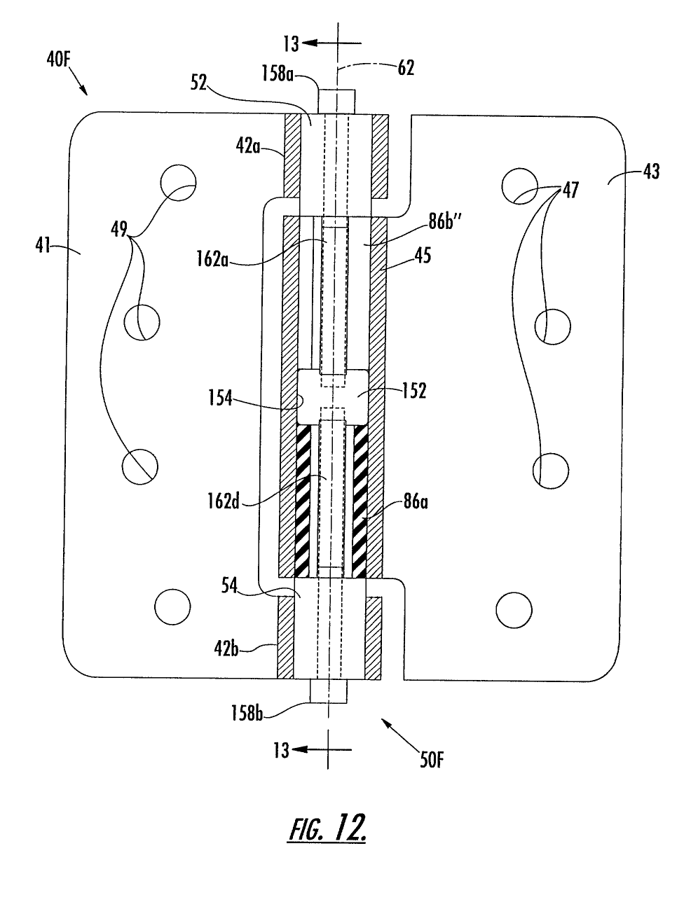

A sixth embodiment hinge 40F is illustrated in FIGS. 12, 13 and 14. The hinge 40F comprises the attachment members 41 and 43 of the previously described hinge embodiments as well as layers 86b, 86b″ and 86a, 86a″ described in fifth embodiment hinge 40E. An integral shaft is comprised of first and second shaft members 160a and 160b with locator element 152 between the inner shaft ends. The locator and shafts are made integral by conventional threaded fasteners 158a and 158b that are passed through a slot 156 that extends through the shaft members 160a and 160b and locator 152 when the locator and members are axially aligned. The shaft members comprise substantially the same rectangular cross section as previously described for shaft 80. Additionally, each shaft member includes a pair of axially aligned wedges 150a, 150b, 150c and 150d along opposite lateral shaft surfaces previously identified as 82a and 82b hereinabove. Shaft member 160a includes opposed wedges 150a and 150b and shaft member 160b includes opposed wedge members 150c and 150d. As shown in FIG. 13, the end of each shaft is separated from the locator 152 by a gap that permits the shafts to be displaced axially toward and away from the locator as the fasteners are tightened and loosened. The fasteners may be loosened or tightened independently or they may be adjusted by the same amount.

As shown in FIG. 12, when the hinge 40F is assembled, the locator is seated in the chamber 154 defined by the passageway wall and the ends of layers 86a and 86b′″. The drive shaft 160a includes hub 52 that is provided with a conventional spline, key or similar locking element (not shown) that operatively connects the drive shaft with the first attachment member 41 collar 42a.

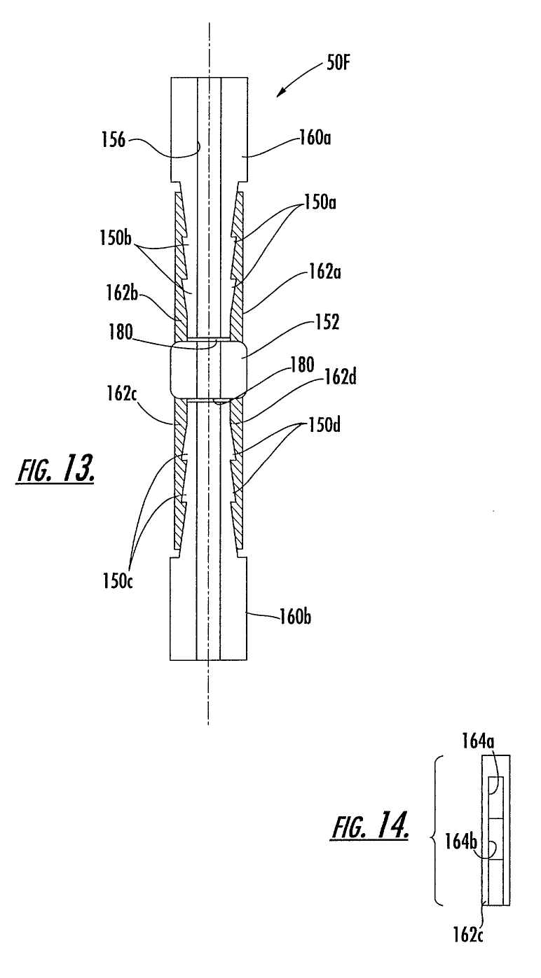

Laterally or radially displaceable shoes 162a, 162b, 162c and 162d are mated with respective wedge pairs 150a, 150b, 150c and 150d. As shown in FIG. 14 which depicts representative shoe 162c, each shoe includes axially aligned, wedge shaped voids 164a, 164b that are adapted to be mated with axially aligned wedge members 150c. In operation, as the fasteners are adjusted, and the shaft members are displaced axially, the cam type engagement between the wedge members and shoes shown in FIG. 13, causes the shoes to be urged laterally as the shaft member is displaced along axis 62 toward the locator 152. The shoes moved inwardly as the shaft is displaced away from the locator. Movement of the shoes inwardly and outwardly decreases and increases the contact forces produced between the shoes and resilient layers 86b, 86b″ and 86a, 86a″ and thereby affects the supplied surface effect damping force. It is believed that the sixth embodiment hinge 40F might also be made position sensitive by providing cam members that rotate with drive shaft members 160a and 160b and relative to the wedges. Camming engagement between the cams and wedges causes the wedges to be displaced axially. In this way the damping is dependent on the magnitude of rotation of the cam members.

In summary the sixth embodiment hinge 40F provides damping in both directions of motion of hinge attachment member 41. The hinge damping is adjustable by screw members 158a and 158b.

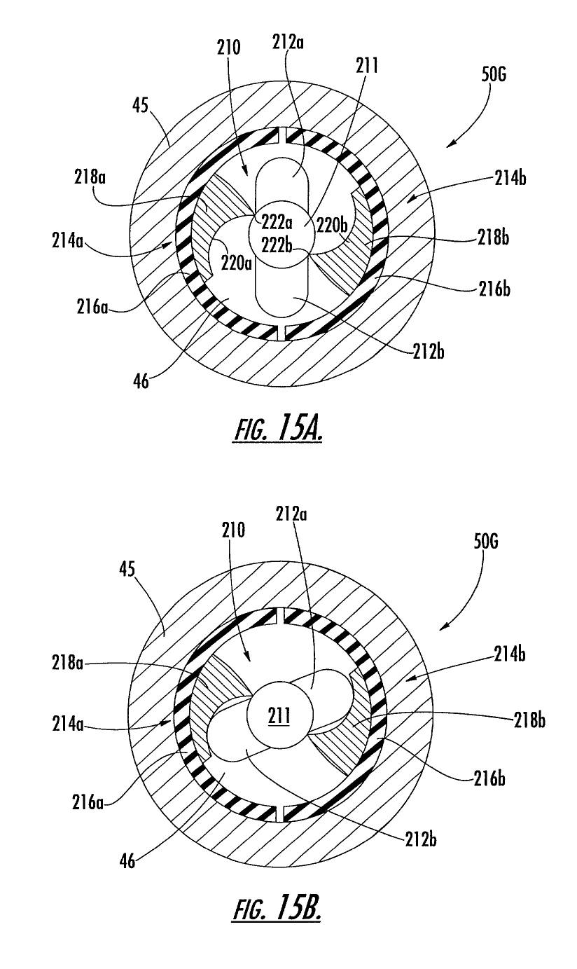

Alternate embodiment coupling members 50G for use with hinge attachment members 41 and 43 are illustrated in FIGS. 15A and 15B. The attachment members comprise collar 45 defining passageway 46 previously described in the foregoing preferred embodiments of the hinge of the present invention. The alternate embodiment coupling member 50G provides damping that is dependent on the angular velocity of shaft 210. Unitary shaft 210 comprises inner shaft member 211 with diametrically opposed arms 212a and 212b that extend radially outwardly from the inner member 211. The shaft is rotatable clockwise and counterclockwise about axis 62.

Movable damping elements 214a and 214b are located in the passageway 46. Each damping element is comprised of an arcuate resilient layer or sleeve 216a, 216b located against the passageway wall and a shoe 218a, 218b made integral with the sleeve to be movable with the respective sleeve 216. As shown in FIGS. 15A and 15B, the sleeves extend about an angle of approximately 180° and the shoes are wedge-shaped with a semi-spherical void provided in each wedge. The sleeves and shoes may be comprised of any resilient material including, but not limited to rubber or plastic. The sleeves and shoes of damping elements 214 may extend axially any suitable distance either completely between the collar ends or along a portion of the length of the passageway.

Turning now to FIG. 15B, rotation of shaft 210 counterclockwise about axis 62 moves arms 212a and 212b into contact with respective movable shoe members 214a and 214b. By the contact between the arms and wedges, the damping elements are displaced in the same counterclockwise direction and the shaft and the wedges are also urged outwardly causing the resilient layers to increase the contact force against the collar wall and thereby increase the friction component of the surface effect damping supplied by the hinge that includes coupling member 50G. Thus damping is provided when the shaft 210 arms engage the wedges to displace the damping elements and impart radially directed outward wedge displacement. The damping supplied by coupling 50G is velocity dependent. It is believed as the shaft is accelerated, the arms will further engage the wedges, proximate the trailing edges 222a and 222b, thereby abruptly increasing the compressive wedge forces applied to drive the damping layers against the passageway wall and increase the supplied damping.

As shown in FIGS. 15A and 15B, at all times during rotation of shaft 210, the inwardly located trailing wedge edges 222a and 222b are in contact with circular inner shaft member 211. This edge contact between the shoes 220a, 220b and shaft 211, helps to ensure that the damping elements 214a and 214b remain in their required locations in the passageway 46.

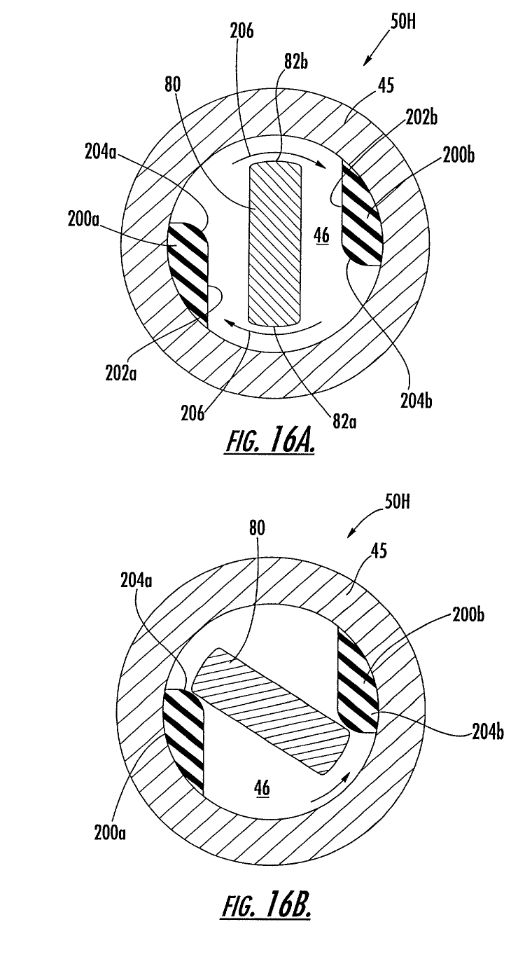

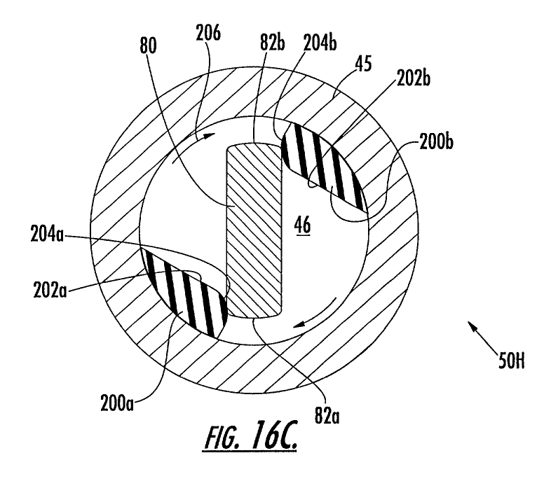

Means for maintaining a fixed distance between the first and second attachment members 41 and 43 may be provided by the coupling member 50H disclosed in the sectional views of FIGS. 16A and 16B. The coupling member 50H may be used in combination with attachment members 41 and 43 previously described. The means for maintaining a fixed distance between the first and second attachment members may be needed when the hinge joins a door, lid or other movable panel to a frame where the door, lid or panel needs to tend to remain in either the open or the closed position.

The opposed elements 200a and 200b for damping the motion of the shaft maintaining a fixed relative displacement between the attachment members are illustrated in FIGS. 16A and 16B. Each element 200a and 200b is fixed to the wall that defines passageway 46 and the elements include damping surfaces 202a and 202b that terminate at one end at respective rounded shoulders 204a and 204b. As disclosed in FIGS. 16A and 16B, the elements as fixed to collar 45 are separated by approximately 180°. The elements 200a, 200b may extend along the entire wall of passageway 46 between the collar ends or may extend along a portion of the passageway wall. As will be described hereinbelow, the elements 200b and 200a supply surface effect damping as well as means for maintaining the door, lid or other movable member open, and the specific design configuration of the elements such as the element length and configuration may be determined based on the magnitude of damping required and the torque o required to overcome the engagement prevent the shaft from counterrotating .

In operation, as the shaft is rotated about axis 62 in a clockwise direction 206, after approximately 45° of shaft rotation the ends 82a and 82b impinge on the elements 202a and 202b and such impingement provides surface effect damping of the shaft displacement. As the thickness of the elements 200a and 200b increases in the direction of rotation the compressive forces increase thereby increasing the frictional component of the surface effect damping supplied. For purposes of describing the operation of hinge as the shaft 80 is rotated clockwise, the movable member such as a door or lid is being opened. Continued clockwise rotation of the shaft further impinges the elements and when the movable member, such as member 41, is located at its desired location such as the open position, the shaft ends 82a and 82b are located downstream from retention shoulders 204a and 204b. When it is necessary to rotate the shaft 80 counterclockwise such as when a door needs to be closed, the shaft ends 82a and 82b engage the shoulders and by such engagement the rotational displacement of the shaft is impeded, thereby maintaining the door, lid or other movable member in the desired position so that the relative distance between the attachment members 41 and 43 constant. Undesired, inadvertent displacement of the door or lid is avoided by requiring a substantial force be applied to the door or lid to move the shaft past the retention shoulders. It is preferred that the door or other movable member be spring biased to move the door toward the closed position and in a counterclockwise direction. In this way, the shaft ends will be moved into abutment with the element shoulders. When a force sufficient to pass the shoulders is supplied to the door, the ends of the shaft 80 again impinge the elements and damping is supplied. The elements may have any suitable cross section including but not limited to a semispherical, and wedge shaped cross sections

It should be appreciated that the elements may be oriented to provide the resistance to movement of the movable member when the member is closed and the attachment members are proximate each other. In such an embodiment shown in FIG. 16C, the elements 200b and 200a and more specifically the element shoulders 204a and 204b are located immediately adjacent the shaft ends 82a and 82b and downstream therefrom in the direction of shaft opening displacement 206. In this way an increased force must be supplied to the movable member to rotate shaft 80 past the shoulders 204a and 204b to thereby open the door. Once the shaft is rotated past the shoulders, the lateral shaft ends impinge upon the body of the element to produce surface effect damping. The magnitude of the surface effect damping decreases as the shaft is rotated clockwise in direction 206.

Additionally, it should be understood that the damping/position check device 50H may have a plurality of elements precisely spaced around the passageway 46 to provide the desired damping forces and also to provide position checking when the movable member is located at first or second limit positions, for example the open and closed positions of a door. Such a device may comprise a combination of the elements shown and described in FIGS. 16A-16C. the check members may be used in combination with any required damping layers or elements previously described hereinabove.

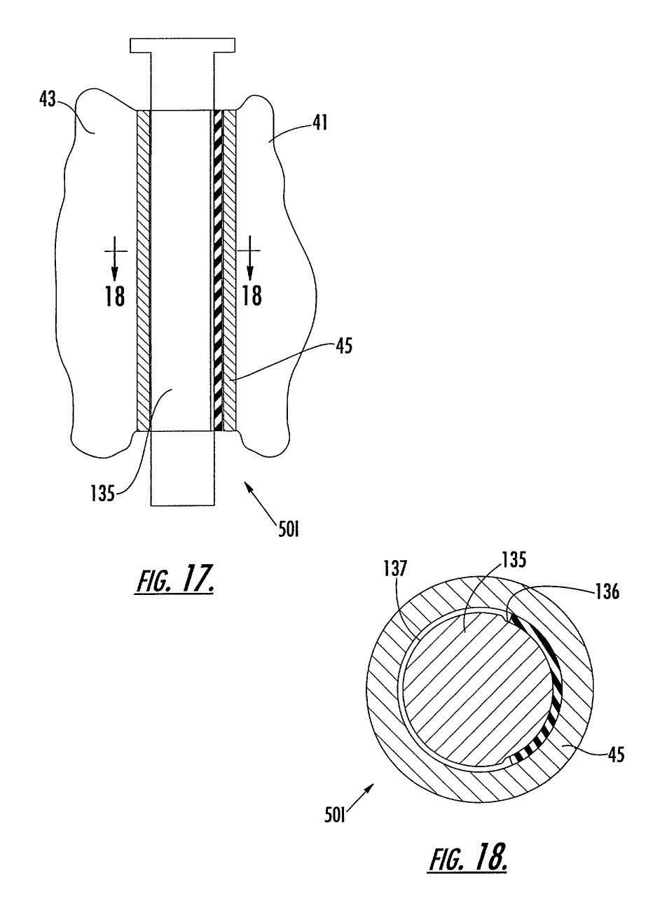

Alternate embodiment coupling member 50I is illustrated in FIGS. 17 and 18. The coupling member may be used in combination with previously disclosed attachment members 41 and 43. The coupling member comprises metal pin member 135 that includes an arcuate relief 136 that extends for approximately 180° around pin member 135. The relief extends along the entire longitudinal length of the pin 135. As shown in FIG. 18, at the termination edges of the relief the diameter of the pin increases. In this way, as the pin rotates in response to displacement of attachment member 41, the resilient layer that is fixed to the passageway wall will be located between the relief surface and the passageway wall to produce surface effect damping and then the magnitude of the surface effect damping will increase when the layer is located between the large diameter portion 137 of the pin 135 and the passageway wall 45.

Thus the coupling member 50I provides damping in both directions of attachment member displacement and also provides angular or positional damping. The magnitude of the damping supplied is varied as the position of attachment member and rotation angle of pin 135 changes.

While we have illustrated and described a preferred embodiment of our invention, it is understood that this is capable of modification and therefore we do not wish to be limited to the precise details set forth, but desire to avail ourselves of such changes and alterations as fall within the purview of the following claims.

We claim:

1. A hinge comprising:
A) a first hinge attachment member;
B) a second hinge attachment member, the first and second hinge attachment members being movable relative to each other; and
C) a coupling member for coupling the first and second hinge attachment members and for supplying damping when the first and second hinge attachment members are displaced relative to each other.

2. The hinge as claimed in claim 1 wherein the second hinge attachment member defines a passageway, said coupling member being located in said passageway.

3. The hinge as claimed in claim 1 wherein the damping is surface effect damping.

4. The hinge as claimed in claim 3 wherein the surface effect damping is comprised of frictional components and hysteretic components.

5. The hinge as claimed in claim 1 wherein the first hinge attachment member is stationary and the second hinge attachment member is movable.

6. The hinge as claimed in claim 1 wherein the damping supplied by the shaft is adjustable.

7. The hinge as claimed in claim 1 wherein the means for varying the supplied damping is comprised of a bolt.

8. The hinge as claimed in claim 1 wherein the damping supplied by the shaft is dependent on the rate of displacement of the first member.

9. The hinge as claimed in claim 1 wherein the damping is supplied in fewer than all directions of relative movement of the first and second hinge attachment members.

10. The hinge as claimed in claim 1 wherein damping is supplied independent of the direction of relative displacement of the first and second attachment members.

11. The hinge as claimed in claim 1 wherein the magnitude of the damping is dependent on the magnitude of displacement of the coupling member.

12. The hinge as claimed in claim 1 wherein said coupling member comprises means for maintaining the distance separating the first and second hinge attachment members constant.

13. The hinge as claimed in claim 12 wherein said means for maintaining the distance between the first and second hinge attachment members prevents relative movement between the first and second hinge attachment members in a first relative direction whereby the distance between the first and second attachment members is decreased.

14. The hinge as claimed in claim 12 wherein said means for maintaining the distance between the first and second hinge attachment members prevents relative movement between the first and second hinge attachment members in a second relative direction whereby the distance between the first and second attachment members is increased.

15. The hinge as claimed in claim 1 wherein said coupling member is comprised of a resilient portion having a first end and a second end, a first rigid member made integral with the first resilient member end, a second rigid member made integral with the second resilient member end.

16. The hinge as claimed in claim 15 wherein said coupling member also comprises means for adjusting the damping supplied by the hinge.

17. The hinge as claimed in claim 16 wherein said adjustment means comprises a fastener.

18. The hinge as claimed in claim 17 wherein the fastener extends through the resilient member, first rigid member and second rigid member, the damping forces being increased by compressing the resilient member between the first and second rigid members.

19. The hinge as claimed in claim 15 wherein the second rigid member comprises a closed coupling end, the coupling further comprising a resilient core member located within the resilient member and adjustment means extending through the first rigid member.

20. The hinge as claimed in claim 19 wherein the damping forces being increased by compressing the resilient core member between the fastener and the closed coupling end.

21. The hinge as claimed in claim 1 wherein the coupling member comprises a resilient element and a clamp member surrounding the rubbing member, said clamp element for rubbing against said resilient member, said clamp element comprising damping release means.

22. The hinge as claimed in claim 21 wherein said damping release means is a tab that is engaged when the first and second hinge attachment members are located proximate each other.

23. The hinge as claimed in claim 21 wherein the hinge member is C-shaped with end sections and a middle section that are made integral by a flange, said damping release means extending through the flange.

24. The hinge as claimed in claim 1 wherein said coupling member comprises a shaft and at least two damping layers offset by a distance.

25. The hinge as claimed in claim 24 wherein each damping layer is semicylindrical and each damping layer extends the axial length of the shaft.

26. The hinge as claimed in claim 24 wherein each damping layer has a substantially arcuate cross section.

27. The hinge as claimed in claim 24 wherein the at least two damping layers are separated by an angle of about 180 degrees.

28. The hinge as claimed in claim 24 wherein as the shaft is displaced along its path of displacement, at certain locations along the path the shaft is not in contact with the damping layers and at other locations along the path the shaft is in contact with the damping layers.

29. The hinge as claimed in claim 25 wherein the damping is minimized when the shaft is located at the leading and trailing edges of the damping layers and is at a maximum when the shaft is located at substantially the center of the layers.

30. The hinge as claimed in claim 26 wherein the damping is substantially constant when the shaft is in contact with the damping layers.

31. The hinge as claimed in claim 24 wherein the coupling member comprises first and second layers that extend along a portion of the shaft length and third and fourth layers that extend along the other portion of the shaft length, the third and fourth layers being offset axially from the first and second layers by a distance.

32. The hinge as claimed in claim 1 wherein the coupling member is comprised of a first shaft member, a second shaft member, at least one resilient layer surrounding at least a portion of the shaft length, said shaft members also comprising at least one wedge along the shaft, said coupling member further comprising shoes engagable with the wedge member, and adjustment means for displacing each shaft axially to thereby move the shoes toward and away from the corresponding shaft and the resilient layers.

33. The hinge as claimed in claim 1 wherein the coupling member comprises a movable shaft and at least two damping elements each comprising a resilient layer and an inwardly located shoe adapted to be engaged by said shaft, the magnitude of the shaft engagement being dependent on the velocity of the shaft.

34. The hinge as claimed in claim 1 wherein the coupling member comprises a movable shaft having a minimum diameter portion and a maximum diameter portion, and a fixed resilient portion, the damping being greater when the resilient portion is in contact with the maximum diameter portion than when the resilient member is in contact with the minimum diameter portion of the shaft.

35. The hinge as claimed in claim 1 wherein the coupling member includes a volume of lubricant.

36. A hinge comprising:
A) a first hinge attachment member;
B) a second hinge attachment member, the first and second hinge attachment members being movable relative to each other; and
C) a coupling member for coupling the first and second hinge attachment members and for supplying dynamic surface effect damping when the first and second hinge attachment members are displaced relative to each other.
